(19) United States
(12) Patent Application Publication
(10) Pub. No.: US 2026/0146379 A1
(43) Pub. Date: May 28, 2026

(54) ENGINEERED COMPOSITE TEXTILE

(71) Applicant: NIKE, Inc., Beaverton, OR (US)

(72) Inventors: Martin E. Evans, Portland, OR (US); Matthew D. Nordstrom, Portland, OR (US)

(73) Assignee: NIKE, Inc., Beaverton, OR (US)

(21) Appl. No.: 19/395,146

(22) Filed: Nov. 20, 2025

Related U.S. Application Data
(60) Provisional application No. 63/723,907, filed on Nov. 22, 2024.

(51) Int. Cl. D04H 1/66; A43B 1/04; B32B 5/02; B32B 5/26; D04H 1/587

(52) U.S. Cl. CPC D04H 1/66; A43B 1/04; B32B 5/022; B32B 5/024; B32B 5/026; B32B 5/275; D04H 1/587; B32B 2250/02; B32B 2250/20; B32B 2437/02; D10B 2501/043

(57) ABSTRACT

A method of manufacturing an engineered composite textile includes winding a yarn across a winding jig to form a plurality of yarn strands extending across the winding jig, stacking the winding jig with the plurality of yarn strands onto a base textile; and digitally printing a polymeric bonding material in a predetermined pattern across the plurality of yarn strands to bond the yarn strands to the base textile to create an engineered composite textile.

### CROSS REFERENCE TO RELATED APPLICATIONS

The present application claims the benefit of priority from U.S. Provisional Patent No. 63/723,907, filed 22 Nov. 2024, which is incorporated by reference in its entirety.

### TECHNICAL FIELD

The present disclosure relates generally to engineered composite textiles and other yarn-based composite structures. More specifically, aspects of this disclosure relate to systems, methods, and devices for automated fabrication of engineered composite textiles for footwear and apparel.

### BACKGROUND

In typical apparel production, discrete patterns/panels are cut from a pre-produced roll or bolt of fabric and then seamed together to form the final article. To maintain its integrity as a sheet, the rolled fabric must include its own intrinsic structure, which often takes the form of a weave or knit. In many instances, this structure is needed only to provide integrity to the fabric and has no functional purpose in the completed article.

The roll of fabric typically comprises a textile having a repeating yarn structure that is application agnostic. In general, a textile is any sheet or rolled material constructed from a plurality of interconnected fibers, filaments, or yarns characterized by flexibility, fineness, and a high ratio of length to thickness. Textiles generally fall into two categories. The first category includes textiles produced directly from webs of filaments or fibers by randomly interlocking to construct non-woven fabrics and felts. The second category includes textiles formed through a mechanical manipulation of yarn, thereby producing a woven or knitted fabric, for example.

Yarn is the raw material utilized to form textiles in the second category. In general, yarn is defined as an assembly having a substantial length and relatively small cross-section that is formed of at least one filament or a plurality of fibers. Fibers have a relatively short length and require spinning or twisting processes to produce a yarn of suitable length for use in textiles. Common examples of fibers are cotton and wool. Filaments, however, have an indefinite length and may merely be combined with other filaments to produce a yarn suitable for use in textiles. Modern filaments include a plurality of synthetic materials such as rayon, nylon, polyester, and polyacrylic, with silk being the primary, naturally occurring exception. Yarn may be formed of a single filament, which is conventionally referred to as a monofilament yarn, or a plurality of individual filaments grouped together. Yarn may also include separate filaments formed of different materials, or the yarn may include filaments that are each formed of two or more different materials. Similar concepts also apply to yarns formed from fibers. Accordingly, yarns may have a variety of configurations that generally conform to the definition provided above.

The various techniques for mechanically manipulating yarn into a textile include interweaving, intertwining and twisting, and interlooping. Interweaving is the intersection of two yarns that cross and interweave at right angles to each other. The yarns utilized in interweaving are conventionally referred to as warp and weft. Intertwining and twisting encompasses procedures such as braiding and knotting where yarns intertwine with each other to form a textile. Interlooping involves the formation of a plurality of columns of intermeshed loops, with knitting being the most common method of interlooping.

In certain items of functional apparel (e.g., footwear, sports bras, compression gear (e.g., shorts, pants, shirts, sleeves), joint braces (e.g., ankle, knee, wrist, elbow), and certain wearable accessories), the performance of the article depends on certain strength and/or elasticity in specific directions. For example, a compression sleeve for a leg may require a particular circumferential elasticity to provide optimal compression, though may also require a particular longitudinal elasticity across the anterior portion of the knee to permit joint flexure. Footwear involves even more complex motions with lateral containment requirements to promote stability on the footbed, pronation/supination, and dorsiflexion during a typical gait. In many instances, the intrinsic structure of pre-produced textile is suboptimally arranged to meet the functional demand requirements of the article.

### BRIEF DESCRIPTION OF THE DRAWINGS

FIG. 1 is a schematic a side profile of an article of footwear having an upper that incorporates an embodiment of engineered composite textile.

FIG. 2 is a schematic perspective view of a textile structure 20 that may be formed with a knitting machine such as a wide-tube circular knitting machine.

FIG. 3 is a schematic plan view of a textile pattern that is suitable for forming an upper of an article of footwear.

FIG. 4 is a schematic a side profile of an article of footwear.

FIG. 5 is a schematic plan view of an engineered textile that may be used to form a portion of an upper of an article of footwear.

FIG. 6 is a schematic perspective exploded view of multiple layers of yarn strands that may be joined with a base textile to form an engineered composite textile.

FIG. 7 is a schematic perspective view of an embodiment of a pin jig that is wound with a yarn to form a plurality of yarn strands suitable for use in an engineered composite textile.

FIG. 8 is a schematic illustration of a system for printing a polymer onto a plurality of yarn strands.

FIG. 9A is a schematic plan view of component of an upper having a polymer-adhered sole component.

FIG. 9B is a schematic side view of an article of footwear formed in part from the upper component of FIG. 9A.

FIG. 10 is a schematic flow diagram of a method of manufacturing an engineered textile.

FIG. 11 is a schematic exploded view of a first embodiment of an engineered composite textile.

FIG. 12 is a schematic exploded view of a second embodiment of an engineered composite textile.

FIG. 13 is a schematic exploded view of a third embodiment of an engineered composite textile.

FIG. 14 is a schematic exploded view of a fourth embodiment of an engineered composite textile.

FIG. 15 is a schematic exploded view of a fifth embodiment of an engineered composite textile.

FIG. 16 is a schematic exploded view of a sixth embodiment of an engineered composite textile.

FIG. 17 is a schematic exploded view of a seventh embodiment of an engineered composite textile.

FIG. 18 is a schematic exploded view of an eighth embodiment of an engineered composite textile.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, the disclosure is to cover all modifications, equivalents, combinations, sub-combinations, permutations, groupings, and alternatives falling within the scope of this disclosure as encompassed by the appended claims.

### DETAILED DESCRIPTION

The present disclosure broadly relates to engineered composite textiles and/or textile-like composite structures, methods for creating the same, and the integration and use of such composite textiles in constructing articles of apparel, including, without limitation, articles of functional apparel. As used herein, the term “functional apparel” is intended to include any article of apparel or footwear that has a use or purpose beyond simply aesthetics or body coverage. Examples of functional apparel may include articles of footwear, bras (e.g., sports bras), compression gear (e.g., shorts, pants, shirts, sleeves), joint braces (e.g., ankle, knee, wrist, elbow), and/or accessories or wearables (e.g., backpacks, bags, watch bands).

Generally speaking, the composite textiles presented herein incorporate oriented yarn strands that are bonded to an underlying base textile to augment the natural material parameters of that underlying base textile. This combination provides the composite textile with a more directionally controlled strain response, and in some instances, improved durability/abrasion resistance. In doing so, an apparel/footwear designer may have more design freedom to specify directional elasticities and strengths (e.g., tensile strength, sheer strength, etc.) of the textile panel without being constrained solely to the repeating intrinsic structure of the base textile, which is often a product of the structure of roll of fabric from which the panel was cut.

In general, the present designs/techniques create a new class of application-specific, textile-like composite structures that are engineered to provide specific directional material properties that are tailored to the end use of the textile. For the purpose of this disclosure, these composite structures will be broadly referred to as “engineered textiles.” Such engineered textiles may have a material structure that includes a plurality of oriented and non-interlocking yarn strands that extend across a respective pattern/panel and that are selectively secured together and to the textile via the application of an overlaid bonding material. By forming the engineered textile in this manner, the yarn strands may be aligned with expected load paths or the directions of expected tensile loading during use (e.g., when being worn by a user during daily activities including sporting activities, etc.) in the final article. For example, elevated tensile and sheer forces are expected in footwear uppers when playing basketball, tennis, football, and other court-based or field-based sport activities. In such activities, reasonably expected load paths can include those orientated along a medio-lateral axis relative to the footwear and the user's foot when accelerating or decelerating in a side-to-side direction, or orientated along a longitudinal axis when accelerating or decelerating in a forward or rearward direction, or along a variety of axes orientated at an angle relatively to a longitudinal axis of the footwear and the user's foot other than directly perpendicular to the longitudinal axis, such as when accelerating or decelerating along such angled axes. An ordinarily skilled artisan with recognize through this description that reasonably ‘expected load paths’ can be different in functional apparel intended for use primarily when performing one type of activity versus one or more other activities. Moreover, the elasticity of each yarn strand can be selected to control the dynamic response of the engineered textile to an applied load during use.

While these engineered textiles may be utilized with any article of functional apparel, they may find particular utility within the field of footwear construction, as footwear design is a unique blend of form and function with numerous competing design considerations. More specifically, a shoe must be sufficiently stiff to provide proper containment, while being sufficiently flexible to allow the foot to naturally move and flex. In this context, by selecting and placing/orienting yarn strands with appropriate elasticities, the engineered textile may achieve specific and deliberate directional strengths at the lowest possible weight or fiber density.

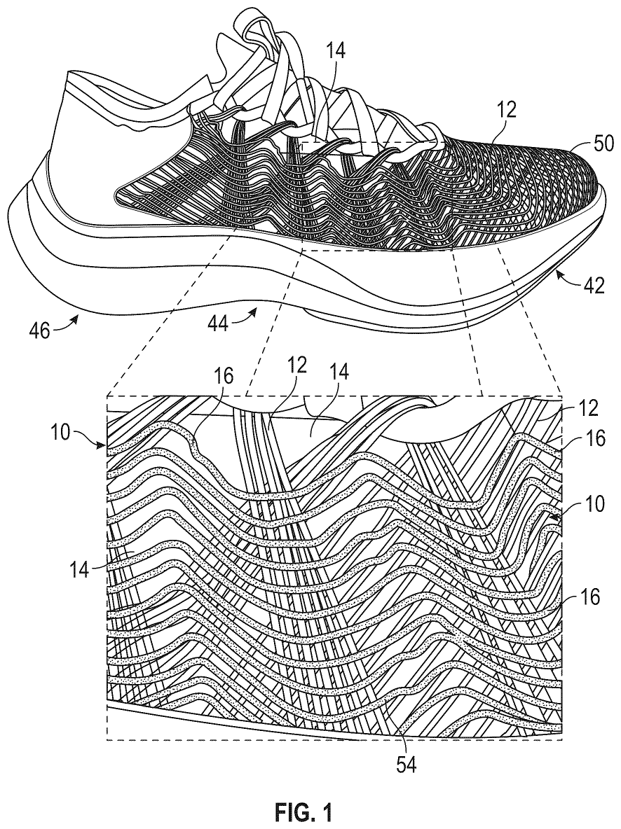

As generally illustrated in FIG. 1, an engineered textile 10 of the kind discussed herein may comprise a plurality of yarn strands 12 that are bonded or otherwise interconnected to a base textile 14 by way of a bonding material 16. As used herein, the term “yarn” or “yarn strand” is understood to refer to a long or essentially continuous strand of fibers, or filament(s) in a form suitable for knitting, weaving, crocheting, braiding, or otherwise mechanically intertwining with other yarns or segments of the same yarn, or for use in sewing including embroidery. Types of yarns include continuous filament yarns, examples of which include monofilament yarns (consisting of a single continuous filament) and multi-filament yarns (consisting of a plurality of flat or textured filaments which are typically twisted or air-entangled with each other). Spun yarns are another type of yarn, which consist of a plurality of staple fibers (such as cotton or wool fibers) or cut fibers or filaments which are entangled with each other in the spinning process. Complex yarns are yet another type of yarn, which may consist of a cord or cabled yarn, or which may consist of two or more single yarn strands combined into a ply yarn. Natural fibers or filaments may be used, including naturally occurring cellulosic fibers such as cotton or flax, naturally occurring protein-based fibers or filaments such as wool or silk, and naturally occurring mineral-based materials such as asbestos. Man-made fibers or filaments may be used, including man-made fibers or filaments made from inorganic materials such as glass or metals, as well as fibers or filaments made from regenerated natural polymers, including cellulose-based polymers and protein-based polymers, man-made carbon fibers or filaments, and man-made fibers or filaments made from synthetic polymers. In many cases, the synthetic polymers are thermoplastics, including thermoplastic elastomers, although thermosets such as elastane may also be used. Synthetic polymers commonly used to make fibers or filaments include polyesters (such as polyethylene terephthalate (PET)), polyamides (such as Nylon-6, Nylon 6,6, and Nylon-11), polyolefins (such as propylene homopolymers and copolymers, as well as ethylene homopolymers and copolymers), and polyacetates (such as cellulose acetate fibers). Polyurethanes, such as thermoplastic polyurethanes, may also be used to make fibers or filaments. The strands may comprise or consist of yarn including natural fibers or filaments, man-made fibers or filaments, or a combination of both natural and man-made fibers or filaments, such as a spun yarn comprising a blend of cotton and polyester fibers. The strands may comprise or consist of a multi-filament yarn comprising polyester or polyamide filaments, such as a commercially available embroidery thread.

Generally, industrial knitting machines and other industrial-scale manufacturing processes require the use of yarns having a minimum tenacity of about 1.5 grams per denier. Tenacity refers to the amount of force needed to break a yarn divided by the linear mass density of the yarn and is determined by subjecting a sample of the yarn to a known amount of force until the sample breaks, for example, using a strain gauge load cell. Lower tenacity yarns have tenacities ranging from about 2.5 to about 4 grams per denier, while medium tenacity yarns have tenacities ranging from about 5 to about 10 grams per denier. Yarns having tenacities greater than about 11 grams per denier are considered to be high tenacity yarns. High-tenacity yarns may include fibers or filaments comprising polymer such as aramids and ultra-high molecular weight polyethylene (UHMWPE). The yarns used in accordance with the present disclosure can be lower tenacity yarns, medium tenacity yarns, high tenacity yarns, or any combination thereof. In some examples, the strands may comprise or consist of a spun yarn, a mono-filament yarn, or a multi-filament yarn having a tenacity of at least 1.5 grams per denier, or of at least 2.5 grams per denier. In other examples, the strands may comprise or consist of a multi-filament yarn having a tenacity of at least 11 grams per denier.

The bonding material used to bond the yarn strands to the base textile is a polymeric material comprising one or more polymers. All of the polymers present in the bonding material (i.e., all of the one or more polymers) are referred to as the bonding material polymeric component. The bonding material may also include one or more optional non-polymeric ingredients, referred to as the bonding material non-polymeric component. Examples of non-polymeric ingredients include fillers, processing aids, anti-yellowing additives, plasticizers, pigments, and any combinations thereof. The bonding material may be a thermoplastic bonding material comprising one or more thermoplastic polymers. The bonding material may be an elastomeric bonding material comprising one or more elastomeric polymers. An elastomer may be defined as a material having an elongation at break greater than 100 percent, or greater than 200 percent, or greater than 400 percent, as determined using ASTM D-412-98 at 25 degrees Celsius. The elastomeric bonding material may have an elongation at break greater than 100 percent, or greater than 200 percent, or greater than 400 percent, as determined using ASTM D-412-98 at 25 degrees Celsius. The bonding material may be a thermoplastic elastomeric bonding material comprising one or more thermoplastic elastomers. At the point that the bonding material is applied to the yarn strands, it may be thermoplastic, and may remain thermoplastic after solidifying. In one example, prior to being applied to the yarn strands, the bonding material may comprise pre-polymers, such as two pre-polymers which react with each other in a polymerization reaction, and which cure into a solid bonding material (typically a thermoset solid bonding material) after being applied to the yarn strands. In another example, at the point the bonding material is applied to the yarn strands, it may be thermoplastic, and may solidify into a thermoset bonding material (e.g., if a crosslinking reaction is initiated during the printing or extruding step, or during the solidification step), or, after application and solidification, a solid thermoplastic bonding material may be crosslinked to form a thermoset bonding material (e.g., if a solid bonding material is crosslinked using electron beam radiation, or if a reactive solid bonding material is cured by exposure to heat or moisture). In such examples, the bonding material may further comprise a polymerization initiator or cross-linking agent when it is applied to the yarn strands.

The one or more polymers of the bonding material (i.e., the polymeric component of the bonding material) may comprise or consist essentially of one or more thermoplastic elastomer (TPE), including a TPE chosen from a thermoplastic polyurethane elastomer, a thermoplastic polyester elastomer, and a thermoplastic styrene-ethylene/butylene-styrene (SEBS) block copolymer elastomer. The one or more polymers of the bonding material may comprise or consist essentially of one or more crosslinked elastomers, such as polybutadiene or polyisoprene, or a polysilane or polysiloxane. The one or more polymers of the bonding material may comprise or consist essentially of a thermoplastic vulcanizate (TPV) including a crosslinked elastomer phase distributed in a continuous thermoplastic phase. The one or more polymers of the bonding material may comprise or consist essentially of a polymer chosen from a polyurethane, a polyurea, a polyester, a polyether, a vinyl polymer, a polyolefin, an acetate polymer, an acrylate or methacrylate polymer, a polystyrene, a polysilane, a polysiloxane, a polycarbonate, and any combination thereof, including homopolymers and copolymers thereof. The one or more polymers of the bonding material may comprise or consist essentially of a polyurethane, including a polyurethane chosen from an elastomeric polyurethane, a thermoplastic polyurethane (TPU), an elastomeric TPU, and combinations thereof. The thermoplastic elastomeric TPU may comprise or consist essentially of a polyurethane copolymer such as a polyester-polyurethane or a polyether-polyurethane or a combination thereof. The one or more polymers of the bonding material may comprise or consist essentially of polyurea. The one or more polymers of the bonding material may comprise or consist essentially of a polyamide homopolymer, or of a polyamide copolymer, including a polyether block polyamide (PEBA) copolymer. The one or more polymers of the bonding material may comprise or consist essentially of a vinyl copolymer such as ethylene-vinyl acetate (EVA) or ethylene-vinyl alcohol (EVOH). The one or more polymers of the bonding material may comprise or consist essentially of a polyolefin homopolymer or copolymer, such as a polypropylene or polyethylene homopolymer, or a copolymer of propylene or ethylene. The one or more polymers of the bonding material may comprise or consist essentially of a styrene copolymer such as poly(styrene-butadiene-styrene) (SBS), or a styrene-ethylene/butylene-styrene (SEBS) block copolymer. The polymer can comprise or consist essentially of one or more thermoplastic polymers selected from the group consisting of a polyester, a polyamide, a polyurethane, a polyolefin, homopolymers and copolymers of each, and combinations thereof.

While a single bonding material may be used as described herein, a first and a second bonding material may also be used. The first and second bonding materials may be used to bond different areas of a single set of yarn strands or may be used to bond different layers of yarn strands, such as first and second layers of yarn strands. The polymeric component of the first and second bonding polymers may both comprise one or more shared polymers, such as, for example, one or more shared TPEs. The polymeric component of the first and second bonding materials may consist of the same polymers but in different proportions. The polymeric component of the first and second bonding materials may consist of the same polymers in the same proportions. The first and second bonding materials may differ from each other only in the type or concentration of pigments present.

The base textile 14 is primarily formed from one or more yarns that are mechanically manipulated through, for example, an interweaving, intertwining and twisting, or interlooping process. Interweaving is the intersection of two yarns that cross and interweave at right angles to each other. The yarns utilized in interweaving are conventionally referred to as warp and weft. Intertwining and twisting encompasses procedures such as braiding and knotting where yarns intertwine with each other to form a textile. Interlooping involves the formation of a plurality of columns of intermeshed loops, with knitting being the most common method of interlooping. The base textile 14 may, therefore, be formed from one of these processes for manufacturing a textile.

In one embodiment, the base textile 14 may be a knitted material. In general, this knitted material may be formed through mechanical processes that can broadly be classified as either warp knitting or weft knitting. With regard to warp knitting, various specific sub-types that may be utilized to manufacture a textile include tricot, raschel, and double needle-bar raschel (which further includes jacquard double needle-bar raschel). With regard to weft knitting, various specific sub-types that may be utilized to manufacture a textile include circular knitting and flat knitting.

In one particular embodiment, the base textile 14 may be a knitted material that is formed on a wide-tube circular knit machine. A wide-tube circular knitting machine forms a generally cylindrical textile structure and is capable of forming various types of stitches within a single textile structure. In general, the wide-tube circular knitting machine may be programmed to alter the design on the textile structure through needle selection. That is, the type of stitch that is formed at each location on the textile structure may be selected by programming the wide-tube circular knitting machine such that specific needles either accept or do not accept yarn at each stitch location. In this manner, various patterns, textures, or designs may be selectively and purposefully imparted to the textile structure.

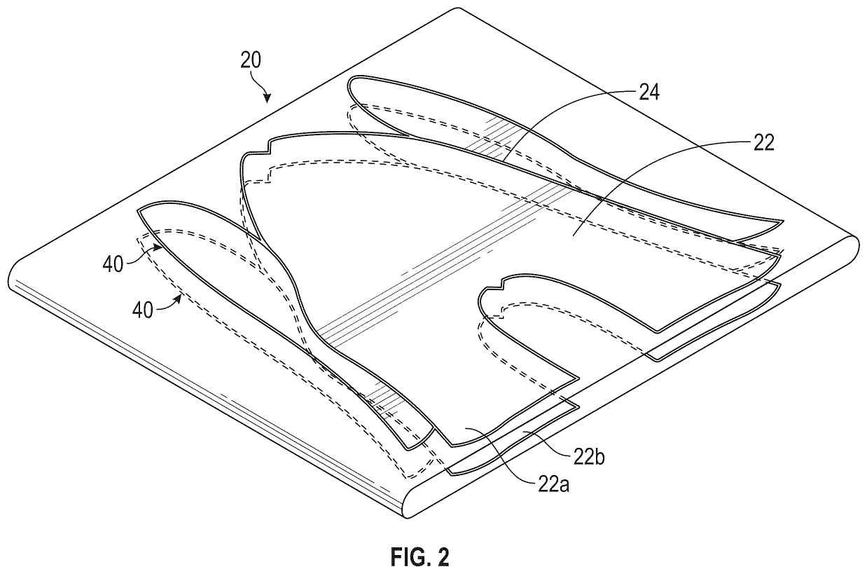

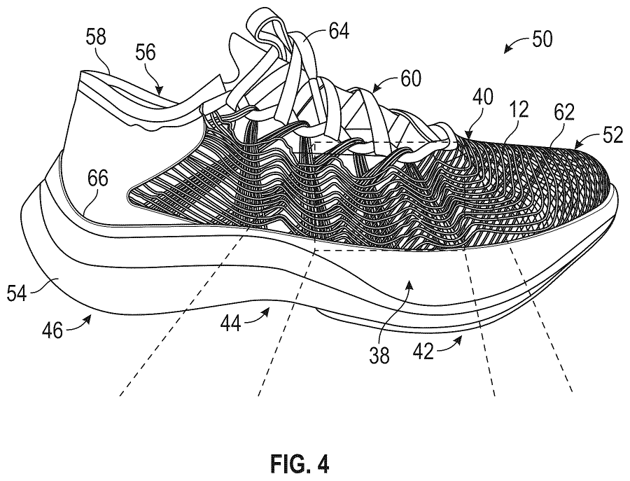

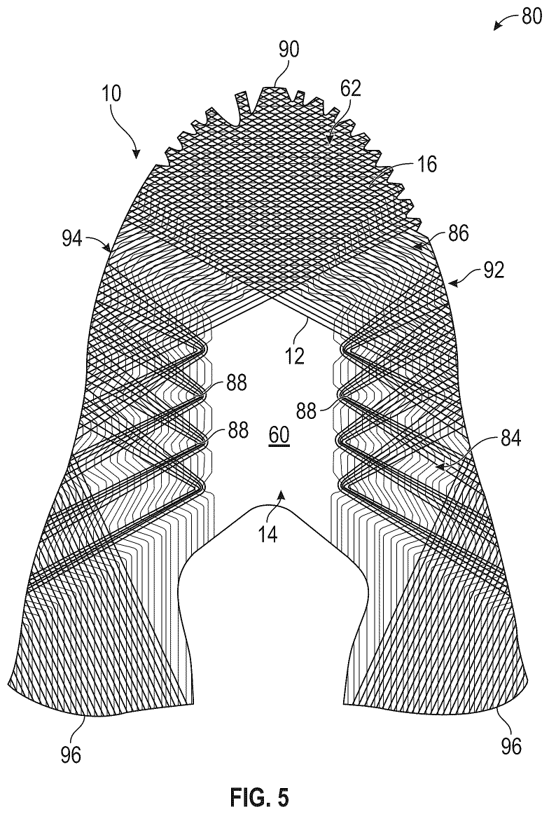

An example of a textile structure 20 that may be formed with a wide-tube circular knitting machine is depicted in FIG. 2. This textile structure 20 has a generally cylindrical configuration, and the types of stitches vary throughout textile structure 20 to form a textile pattern 22 (or simply “pattern 22”) within the material. More specifically, the differences in the stitches within textile structure 20 form an outline 24 with the shape and proportions of a pattern 22 that may subsequently be used in constructing an article of footwear or apparel. In the illustrated embodiment, the pattern 22 is suitable for use in constructing an upper of an article of footwear (discussed below an in connection with FIGS. 4-5).

As further illustrated in FIG. 2, a portion of each textile structure 20 corresponding to a pattern 22 may be removed from the rest of the textile structure 20 through one or more secondary processes such as die-cutting, laser-cutting, or other conventional cutting operations. As shown in FIG. 2, the outline 24 of the pattern 22 (i.e., a first pattern 22a) is depicted on a front portion of textile structure 20, and the outline of another pattern 22 (i.e., a second pattern 22b) is depicted on a rear portion of textile structure 20. Accordingly, in some embodiments the first pattern 22a and the second pattern 22b may be simultaneously formed in a single textile structure 20 through a single cutting/separating technique that extends through both the front portion and the rear portion of the textile structure 20.

While FIG. 2 depicts the pattern 22 as having a generally smooth, non-varied stitch configuration (i.e., similar stitches are utilized throughout the pattern 22 to impart a common texture to the various portions of the pattern 22). As discussed above, however, a wide-tube circular knitting machine is generally capable of forming various types of stitches within a single textile structure 20. The wide-tube circular knitting machine may, therefore, vary the stitches within the pattern 22 to produce various patterns, designs, or textures, for example. Various types of stitches may also be formed with other types of knitting machines.

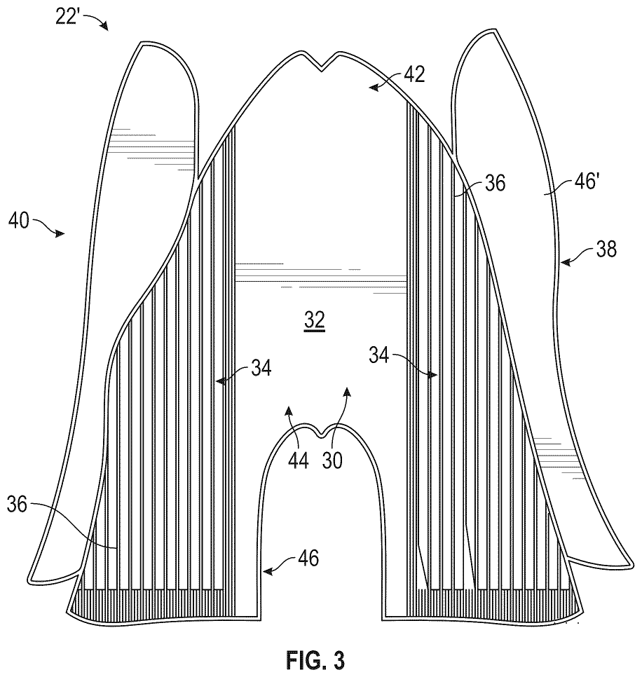

With reference to FIG. 3, a pattern 22′ with the general shape of the footwear upper pattern 22 provided in FIG. 2 is depicted as having various areas with different textures. For example, a central area that corresponds with an instep region 30 has a first texture 32 that is generally smooth. In addition, the pattern 22′ includes a second texture 34 that is a plurality of longitudinal ribs 36. When incorporated into an article of footwear, the ribs 36 will extend longitudinally along lateral side 38 and medial side 40, and the ribs may extend across each of the forefoot region 42, midfoot region 44, and heel region 46. The ribs may be present for aesthetic purposes, or may affect the stretch properties of upper, for example. Accordingly, the footwear upper pattern 22′ exhibits areas with different textures in a single element of textile material. Additional details of suitable knit textile structures are provided in U.S. Pat. No. 8,266,749, which is incorporated by reference in its entirety and for all that it discloses.

FIG. 4 schematically illustrates an embodiment of an article of footwear 50 that utilizes engineered textiles in its construction. While the article of footwear is illustrated for discussion as an athletic shoe or “sneaker,” it should be recognized that this is simply one example application of where the presently disclosed engineered textile may be used. In other applications, however, the present textiles may be incorporated into other aspects of this or other styles of footwear, and/or may be incorporated into any logically relevant article of functional apparel or other type of consumer product. As used herein, the terms “shoe” and “footwear”, including permutations thereof, may be used interchangeably and synonymously to reference any suitable type of garment worn on a human foot. Lastly, features presented in the drawings are not necessarily to scale and are provided purely for instructional purposes. Thus, the specific and relative dimensions shown in the drawings are not to be construed as limiting.

The representative article of footwear 50 (also generically referred to as a shoe 50) is generally depicted in FIG. 4 as a bipartite construction that is primarily composed of a foot-receiving upper 52 mounted on top of a subjacent sole structure 54. For ease of reference, the shoe 50 may be divided into three anatomical regions: a forefoot region 42, a midfoot region 44, and a hindfoot (heel) region 46. The shoe 50 may also be divided along a vertical plane into a lateral side 38—a distal half of the shoe 50 farthest from the sagittal plane of the human body - and a medial side 40—a proximal half of the shoe 50 closest to the sagittal plane of the human body. In accordance with recognized anatomical classification, the forefoot region 42 is located at the front of the shoe 50 and generally corresponds with the phalanges (toes), metatarsals, and any interconnecting joints thereof. The midfoot region 44 is located between the forefoot and heel regions 42 and 46 and generally corresponds with the cuneiform, navicular and cuboid bones (i.e., the arch area of the foot). The heel region 46, in contrast, is located at the rear of the shoe 50 and generally corresponds with the talus (ankle) and calcaneus (heel) bones. Both the lateral and medial segments 38, 40 of the article of footwear 50 extend through all three anatomical regions 42, 44, 46, and each corresponds to a respective transverse side of the shoe 50. While only a single shoe 50 for a right foot of a user is shown in FIG. 4, a mirrored, substantially identical counterpart for a left foot of a user may be provided. Recognizably, the shape, size, material composition, and method of manufacture of the shoe 50 may be varied, singly or collectively, to accommodate practically any conventional or nonconventional footwear application.

With continued reference to FIG. 4, the upper 52 is depicted as having a shell-like construction for encasing a human foot within an internal cavity 56. As illustrated, the upper 52 generally includes an ankle opening 58 that permits ingress of a wearer's foot into the internal cavity 56. In the embodiment shown in FIG. 4, a throat or instep section 60 extends from the ankle opening 58 toward the forefoot region 42 and permits the upper to splay open to aid ingress/egress with the cavity 56. A vamp portion 62 is generally located forward of the throat section 60 and/or in a portion of the upper that covers the phalanges of the foot. With continued reference to FIG. 4, a closure 64 (e.g., shoelace, strap, buckle, or other commercially available mechanism) may extend laterally across the throat section 60 (i.e., in a medial-lateral direction) and may be utilized to modify the girth of the upper 52 to more securely retain the foot within the interior of the shoe 50 as well as to facilitate entry and removal of the foot from the upper 52.

The sole structure 54 is rigidly secured to the upper 52 such that the sole structure 54 extends between the upper 52 and a support surface upon which a user stands. In effect, the sole structure 54 functions as an intermediate support platform that separates and protects the underside of the user's foot from the ground. In addition to attenuating ground reaction forces and providing cushioning for the foot, the sole structure 54 may provide traction, impart stability, and help to limit various foot motions, such as inadvertent foot inversion and eversion. In some embodiments, the sole structure 54 may be attached to the upper 52, for example, via an adhesive or other typical joining means. When joined together and viewed from an external perspective, the line where the upper 52 meets the sole structure 54 may be referred to as the bite line 66.

In general, the purpose of the upper 52 is to achieve proper containment of the wearer's foot, to provide adequate lateral stability, and to permit certain foot flexures in a minimally restrictive manner. Said another way, the upper is tasked with maintaining the sole structure in a stable location relative to the wearer's foot (i.e., minimizing any relative translations) while providing lateral support to prevent the wearer's foot from rolling off the sole structure 54, and providing longitudinal elasticity to enable normal dorsiflexion foot motions throughout a typical gait. As will be discussed below, it has been found that these seemingly competing interests of stability and flexibility can be most efficiently addressed through the use of anisotropic textiles with specifically engineered and directionally-dependent material properties.

FIG. 5 better illustrates the construction of an engineered textile 10 such as shown in FIG. 1, and that is used to form a portion of the upper 52 of a shoe 50 similar to that provided in FIG. 4. In this construction, while certain yarn strands 12 may overlap with other yarn strands 12 throughout the textile panel, they are not interconnected with those overlapping yarn strands except through the bonding material 16. In many embodiments, the bonding material 16 may be deposited across the yarn strands 12 periodically such that for any given strand, there are portions or points of the yarn strand 12 that are uncovered by the bonding material 16 (i.e., the “unbonded portions”) and other portions or points that are contacted by the bonding material 16 (i.e., the “bonded portions”). As generally shown the unbonded portions may alternate with the bonded portions along the length of any given yarn strand 12. In some configurations, such as shown in FIGS. 4-5, the bonding material 16 may follow a continuous bonding material trace path that overlaps or intersects with a plurality of yarn strands 12. Similarly, for any given yarn strand 12, a plurality of bonding material trace paths may overlay or cross the yarn strand 12 to form the plurality of bonded portions.

In a general sense, the plurality of yarn strands 12 may augment the base textile 14 in a manner that would be difficult or seemingly impossible to replicate solely via the interweaving, intertwining, or interloping processes used to form the base textile 14. More specifically, the processes and materials used to form the base textile provide the base textile with an inherent material elasticity that is often a product of how the yarns physically interconnect. While this elasticity is typically a function of the tension, tightness, and/or density of the weave or knit, it is common for a stretch response in one direction to impart a negative stretch response in an off-axis dimension. In the present designs, the yarn strands 12 that are bonded to the base textile 14 can be directly placed along predefined (e.g., ‘expected’) load paths such that a tensile load applied through the engineered textile is largely carried by the yarn strand while imparting little or no undesirable off-axis effects. In doing so, the base textile 14 can be relegated primarily to a coverage function while the functional structure of the engineered textile is largely assumed by the yarn strands 12. Moreover, the bonding material 16 may be used to ensure a consistent spacing of the yarn strands along the base textile 14 while preventing the yarn strands 12 from devolving into a chaotic mess that would otherwise be prone to snagging. As an additional benefit, if the bonding material 16 is applied to an outer surface of the base textile 14 and yarn strands 12, then it may also provide an abrasion resistance to the engineered textile 10 as any foreign object would likely brush against the bonding material prior to engaging with any of the yarn-based structures.

FIG. 5 schematically illustrates a plan view 80 of an engineered textile 10 that may be used to construct an upper of an article of footwear. As shown, the total collection of yarn strands 12 that are bonded to the base textile 14 may include various subsets of constituent yarn strands, where within a given subset of yarn strands, the respective yarn strands 12 of that subset are aligned with each other (either in a parallel or substantially parallel manner, or else extending at angles to each other while originating from a common point). In this particular design, the total collection of yarn strands 12 may generally be divided into subsets 84, 86, each having a different functional purpose. Each yarn strand 12 within the first subset 84 of yarn strands 12 terminates, extends from, or otherwise wraps around a point 88 in the instep or throat region 60 of the article/pattern 22. Conversely, each yarn strand 12 within the second subset 86 of yarn strands 12 extends between points provided on or outside an outer peripheral edge 90 of the pattern 22 without terminating at the throat 60.

In the completed article of footwear, the first subset 84 of yarn strands may be operative to provide sidewall support, circumferential containment, and/or to directly receive a tensile load from the closure 64. In some designs, at least one end of each yarn strand in the first subset 84 may terminate at either a lateral edge 92 or at a medial edge 94 of the pattern.

The second subset 86 of yarn strands may be operative to provide more general support and structure to the upper 52 including in one or both of the heel region 46 or forefoot region 42 of the upper 52. As generally illustrated in FIG. 5, this subset may include yarn strands that extend linearly from a lateral peripheral edge 92 to the medial peripheral edge 94 across the vamp portion 62 and/or yarn strands that extend from a heel seam 96 to one of the lateral or medial peripheral edge 92, 94.

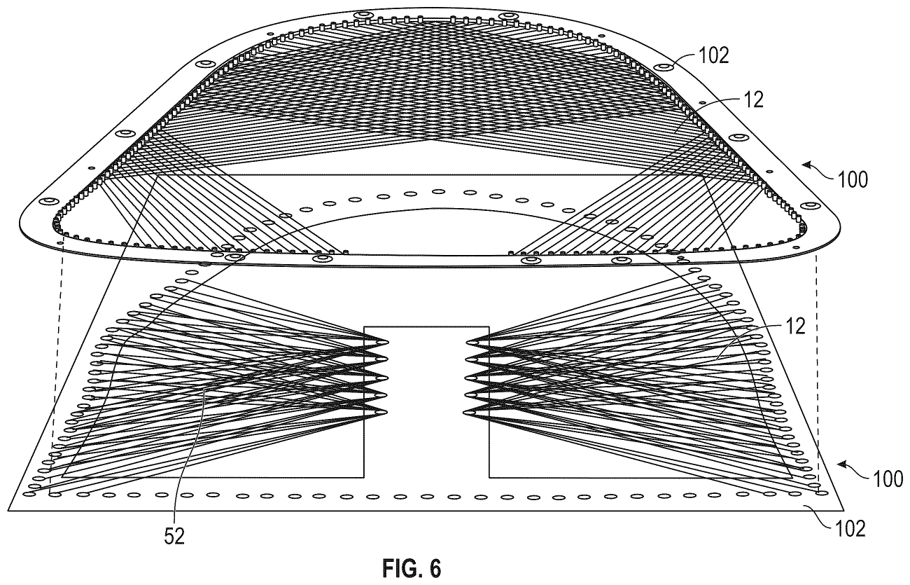

Referring to FIG. 6, in some embodiments, an engineered textile and/or overall yarn structure may be constructed from a plurality of different layers 100 of yarn strands 12, with each layer being separately wound or otherwise formed. In some embodiments, each layer 100 may be wound or otherwise formed on its own respective pin jig 102 and a collection of jigs 102 may be stacked and/or joined to each other while forming the engineered textile 10. The jigs 102 may be designed, sized, or otherwise configured so that when stacked, each layer 100 of yarn strands may be brought into contact with a directly adjacent layer. Further, the jigs 102 may include one or more locating features that, when stacked, ensure proper alignment and registration between the layers. In some embodiments, each yarn layer 100 may be planar or substantially planar. Stacking a plurality of yarn layers, potentially with bonding material disposed in between adjacent layers may provide a z-height stackup and create a thickness to the engineered textile 10 that is greater than a similar thickness of any one layer 100. While FIG. 6 illustrates the stacking of two yarn layers, in some embodiments other materials may be layered between or on top of a portion of the yarn strands to further build the composite structure. As will be discussed more below, this concept of layering may enable other materials such as vinyl, suede, foam, felt, mesh, or the like to be integrated into or joined with the engineered textile to form a larger component with the engineered textile only comprising a portion of the component.

With continued reference to FIG. 6, the mechanical properties of the completed engineered textile may be influenced by the orientation, spacing, tenacity, and elasticity of the yarn strands in each constituent layer 100. Said another way, it is expressly contemplated that different layers may be formed from strands having differing elasticities and/or yarn spacing/density to provide different material stretch responses according to how the force is applied. This may enable the engineered textile to be resilient in one direction and elastic in another (i.e., with those two directions not necessarily being perpendicular to each other as might be the case with a traditionally woven textile).

### Winding

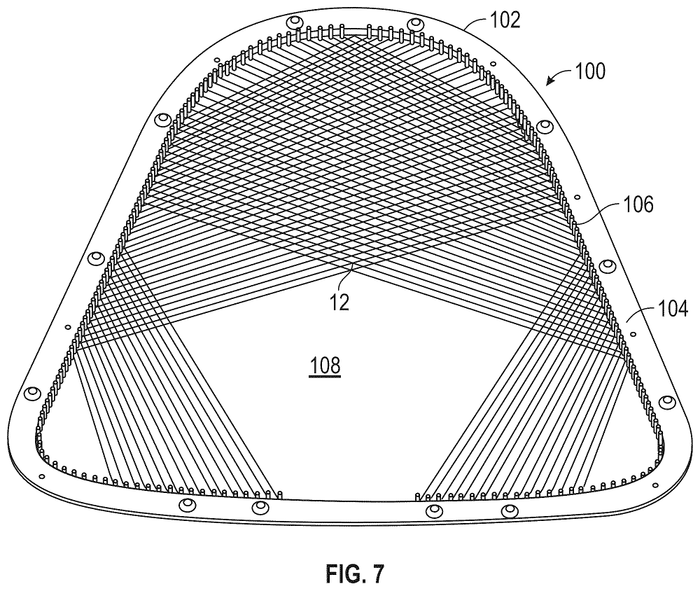

FIG. 7 better illustrates one layer 100 or subset of yarn strands 12 of an engineered textile 10 prior to the strands being secured to the base textile 14. In this illustrated embodiment, the yarn strands 12 may all be approximately co-planar, and each constituent strand may extend linearly between two points provided around the perimeter 104 of a pin jig 102. In general, the pin jig 102 has a plurality of retention features 106 (pins, hooks, teeth) provided along the outer perimeter 104 around which the yarn may be wrapped. In the illustrated embodiment the retention features 106 are upstanding pins that generally extend orthogonal to, or even marginally pitched away from a central area 108 of the jig 102. In other embodiments, the jig may be a tooth-jig that has a plurality of teeth extending outward (in plane) from the central area 108. When creating the yarn strands 12, one or more continuous lengths of yarn may be wrapped or wound around the retention features 106 and across the central area of the jig 108. In doing so, some or all of the yarn strands may be integral to each other during the winding process. For clarity, as used herein, a “yarn strand” is a discrete linear segment of yarn that extends across at least a portion of the workspace or central area 108 of the jig 102 and between two opposite retention features. Due to the winding process, multiple yarn strands may be integral with each other as segments or portions of a single continuous length of yarn.

### Polymer Joining

As noted above, unlike traditional manners of textile construction such as weaving, knitting, crocheting, or braiding, the yarn strands 12 in the present engineered textile 10 do not need to physically entangle, intertwine, weave, knot, loop, or otherwise directly interconnect with other yarn strands in the textile to provide structure. Instead, the present engineered textile utilizes a bonding material 16 to bond/secure the yarn strands 12 to the base textile 14. This bonding material 16 may contact and/or extend between adjacent ones of the plurality of yarn strands 12 to hold the yarn strands 12 in a preestablished pattern relative to the base textile 14.

The bonding material 16 may be applied to the yarn strands 12 using a variety of different techniques and/or computer-controlled manners of selective application that may be collectively or generally referred to as manners of “digital printing”. In some embodiments, these digital printing techniques may involve the bonding material 16 being selectively printed, extruded, or otherwise deposited onto the yarn strands 12 and base textile 14 while in a physical state that is suitable for such processes. Examples of specific digital printing processes or techniques that may be used include bitmap-based printing/material deposition processes (e.g., as may be used with an inkjet-style printer), or vector-based three-dimensional printing processes/deposition modeling (e.g., fused filament textileation). In other embodiments, the bonding material 16 may be applied to the yarn strands 12 via a screen printing process. In still other configurations, the yarn strands 12 may be joined to the base textile 14 through the use of one or more preformed polymeric appliqués that are fused with the strands 12 and base textile 14 through a suitable fusing process (e.g., heat staking, welding, or otherwise chemically bonding).

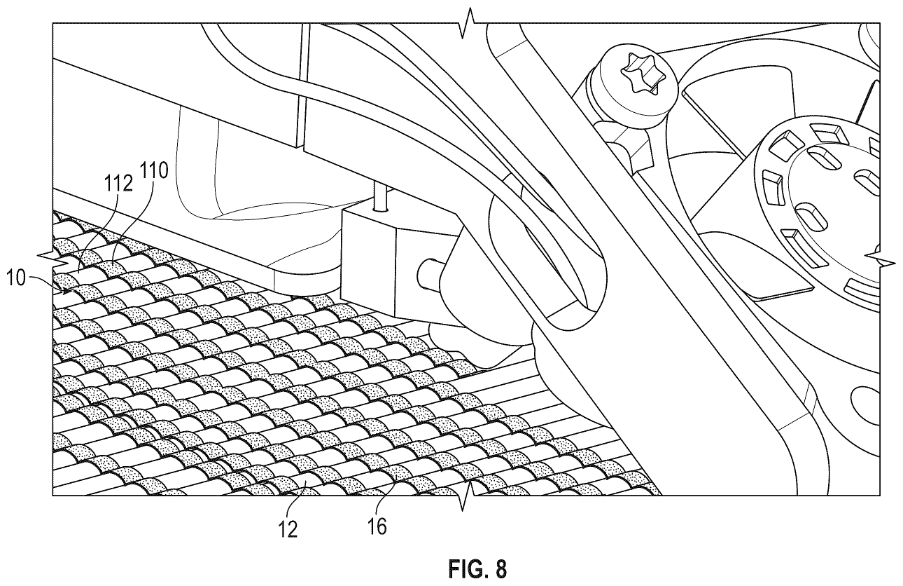

As generally illustrated in FIG. 8, the application of the bonding material 16 to the yarn strands 12 and base textile 14 may be a selective and/or additive process that results in each yarn strand 12 being secured at a plurality of bonded points/portions 110 along its length. These bonded portions 110 may then be separated by respective and alternating unbonded portions 112 where the yarn strand 12 is substantially exposed. The total amount of bonding material applied to the yarn strands 12 and base textile 14 may be expressed as an areal fraction or percentage (bonding material coverage percent), whereby such a percentage may be represented according to the formula: [(bonding material coverage area/total textile area)], with the respective areas being measured in a two-dimensional plan view (i.e., a view parallel to the thinnest dimension of the engineered textile). In some embodiments, the bonding material coverage percentage may be between about 5% and about 95%, or between about 5% and about 50%, or between about 50% and about 95%, or between about 15% and about 35%. In some embodiments, the bonding material coverage percentage may vary across the engineered textile 10. For example, in a shoe context with the upper formed from the engineered textile 10, portions of the heel and/or forefoot areas 46, 42 (e.g., the heel counter and/or the toe box) may have a bonding material coverage percentage of between about 75% and 95%, whereas portions of the midfoot area (e.g., the medial or lateral sidewalls) or vamp may have a bonding material coverage percentage of between about 10% and about 70% or between about 10% and about 50%. In some embodiments, the bonding material coverage percentage may be altered via secondary processes after the application of the bonding material 16 to the yarn strands 12 and base textile 14. For example, in one configuration, the bonding material 16 may be selectively heated and/or pressed to cause the bonding material to spread across a greater area or to provide a stronger bond with the base textile 14 or yard strands 12.

When constructing the engineered textile 10, a wide variety of bonding materials may be used to secure the yarn strands 12 to the base textile 14. A key importance, however, is that, following the joining, the textile 10 retains some degree of the pliability and elasticity of the base textile 14, and does not simply respond like a fiber reinforced composite (e.g., a traditional stiff carbon fiber composite). As such, if harder/less elastic bonding materials are used, they should be used in a lower quantity or at greater spacing to permit the interstitial yarn strands and base textile to react or flex without excessive restriction. If softer bonding materials are used to join the yarn strands 12 with the base textile 14, then the bonding material 16 may be capable of covering larger contiguous areas while still permitting some level of textile flex. In most instances, it may be preferable for the bonding material 16 to have a hardness, measured on the Shore A scale, of between about 10 A and about 70 A. Similarly, in some embodiments, the bonding material 16 may have a material elasticity of between about 5% and about 400% or between about 100% and about 400%, or between about 200% and about 400% when in its finished/solidified form. In some embodiments, different bonding materials, having differing material hardnesses and/or material elasticities, may be used in different portions of the textile/upper to further tune the response characteristics of the final textile/article.

In a very general sense, an engineered textile 10 of the kind described herein can be formed through the stackup of one or more textile layers, one or more winding layers, and one or more bonding material layers. In one construction, the textile 10 may incorporates one textile layer (formed from a base textile 14), one winding layer (including a plurality of yarn strands 12 wound on a jig 102), and two bonding material layers (formed from a bonding material 16 printed into a predefined bonding material pattern). The bonding material layers may operatively attach the yarn strands to the winding layer to the base textile 14 of the textile layer by locally bonding to each.

As noted above, the bonding material 16 may be printed or otherwise extruded into the predefined bonding material pattern while the bonding material 16 is in a state suitable for such a process. Example processes that may be used include screen printing or printing via a deposition modeling (DM) process. Furthermore, in some embodiments, the printing may occur directly onto the yarn strands 12 and/or base textile 14. In other embodiments, however, the entire predefined bonding material pattern may be formed separately and then stacked onto the base textile 14 and/or yarn strand 12 in a cooled or partially cured state. Following this assembly, a separate bonding process (e.g., application of thermal energy) may be applied to facilitate the bonding of the bonding material 16 with the yarn strands 12 and/or the base textile 14.

In some embodiments, following the final application of bonding material, the entire stackup may be pressed, such as with a press pad adapted to apply a pressure against the engineered texture. This press pad may be formed from a material that has a comparatively low surface energy or low affinity for bonding with the selected bonding material 16. In one configuration, the press pad may be formed from a silicone or polytetrafluoroethylene (PTFE) material and may be heated via a heating element to a temperature that is sufficiently high to cause the polymer of the bonding material to soften or reflow. In one embodiment at least a portion of the press pad may be flat or substantially flat such that when it contacts the bonding material 16, it urges the bonding material to spread across a broader area. In some embodiments, the press pad may have a surface texture that may be transferred to the outer surface of the polymer. Finally in some embodiments, at least a portion of the press pad may be debossed such that it either does not contact the bonding material 16, or else contacts the material with a comparatively lower contact pressure. It should be noted that any one press pad may include any combination of flat, textured, and/or debossed portions, and such a design may vary across the surface of the press pad.

While the discussion thus far has focused on using the bonding material to selectively join the yarn strands 12 to the base textile 14, in some configurations, the applied bonding material may also be used to adhere and bond adjacent textile panels or ancillary materials to the base textile as well. For example, in one embodiment, a foam or woven textile trim may be applied to an edge of the engineered textile and bonded to the yarn strands and/or base textile via the applied bonding material. Such a trim piece may include the textile trim around the ankle opening, or the structurally reinforced heel counter. Similarly, in some embodiments, such as shown in FIG. 6, multiple layers of yarn strands may be stacked and joined to create a more dimensioned thickness and structure to the final textile.

In one embodiment, the base textile 14 may be formed from one or more interwoven or interlooped yarns that include a polymer that exhibits a bonding affinity to the polymer used in the bonding material 14. In one configuration the polymer incorporated into the yarns of the base textile 14 may be a thermoplastic polymer. In such an instance, the bonding material may, in some locations, extend between spaced yarn strands 12 and contact the base textile 14. In such a design, the bonding material 16 may bond both mechanically into the structure of the base textile 14, but also may bond at a chemical/material level with the polymer of the base textile 14. This combined style of mechanical and chemical/material attachment may provide a more robust means of attachment than may otherwise be possible. In one embodiment, during the creation of the engineered textile 10, the base textile 14 may be heated prior to applying the bonding material. In doing so, for example, if the bonding material is applied using a deposition, modeling technique, any thermoplastic material in the base textile 14 may more readily melt, reflow, and/or join with the bonding material 16 using only the heat of the bonding material as it exits the printhead.

### Integral Shoe Portions

The present construction techniques provide tremendous design flexibility by allowing a designer to tune the directional elasticities of the textile, while also optimizing the textile's primary expected load paths to minimize shear stresses. In addition to these mechanical properties, the present techniques also provide a new level of functional design. More specifically, a designer may adapt the pattern or placement of the overlaid bonding material to provide functionality beyond just textile integrity/yarn strand interconnection. For example, in a footwear context, the overlaid bonding material may be used to provide a cushioning or traction function and/or to aid in bonding the yarn strands with other materials such as discrete cushioning elements or trim elements. Further, stiffer/harder bonding materials may be additively applied to create discrete reinforcing panels, such as a heel counter or toe bumper.

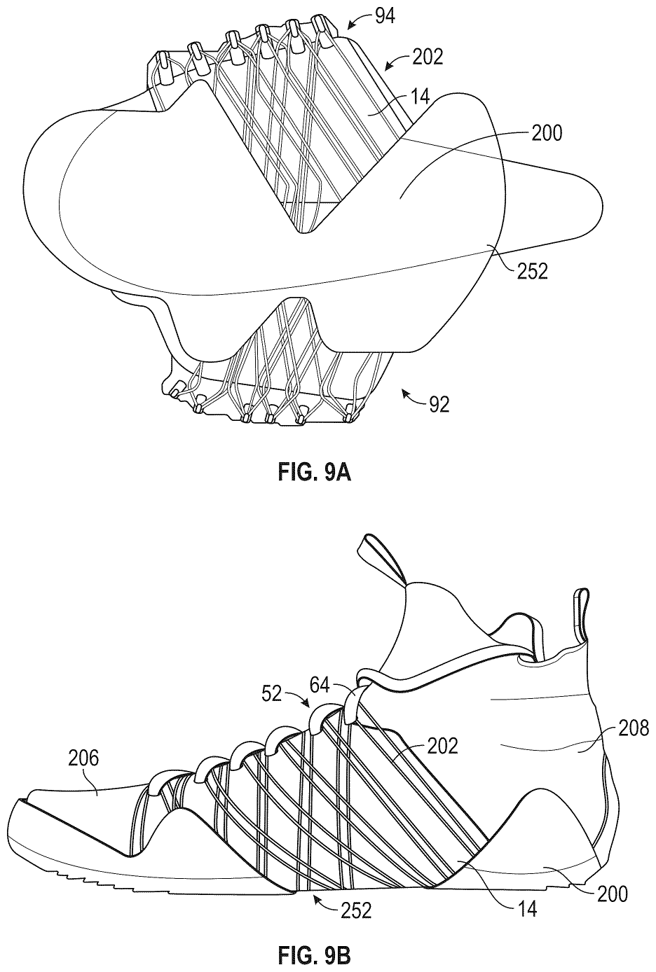

FIGS. 9A-9B schematically illustrate an embodiment of an article of footwear where the applied bonding material forms or otherwise couples a sole component 200 (e.g., an outsole) on an external surface of a containment portion 202 of an upper 52. As generally shown, this containment portion 202 may extend up the sidewalls and may directly engage with the closure 64 to create a proper tension fit around the wearer's foot. This containment portion 202 may extend from the medial side 40 of the article, across an underfoot portion 252, and to the lateral side of the article 38. This portion may further be secured to additional components to form other aspects of the toebox 204, vamp 206, rear quarters 208 and the like.

In this design, an integrated sole component 200 is attached to the underfoot portion 252 of the containment, though may further extend up portions of the medial and lateral sidewalls such as shown in FIG. 9B. In an embodiment, this sole component may either be the first layer of bonding material applied (i.e., bonding material directly printed to the substrate surface of the worktable), or the last layer of applied bonding material (i.e., to the upper surface of the assembly prior to final curing/hardening).

In addition to providing directionally optimized strength/elasticity properties, the presently described engineered textiles may also possess enhanced abrasion resistance by virtue of the overlaid bonding material protruding above the level of the yarn. As such, if the engineered textile were to brush against an abrasive surface, it would likely be the bonding material that would make initial contact rather than the yarn strands, which may more easily fray, snag, or tear. In instances where additional waterproofing may be desired, a thin film elastic membrane may be included with the textile as one of the layers of the assembly. Such a membrane would ideally have sufficient elasticity two prevent the membrane from significantly affecting the material response of the textile. In some embodiments, an elastic membrane may be laminated to the textile on both sides such that all yarn strands are contained between two or more opposing membranes. In this manner, the possibility of inadvertently snagging a strand during normal use would further be reduced.

### Method of Manufacture

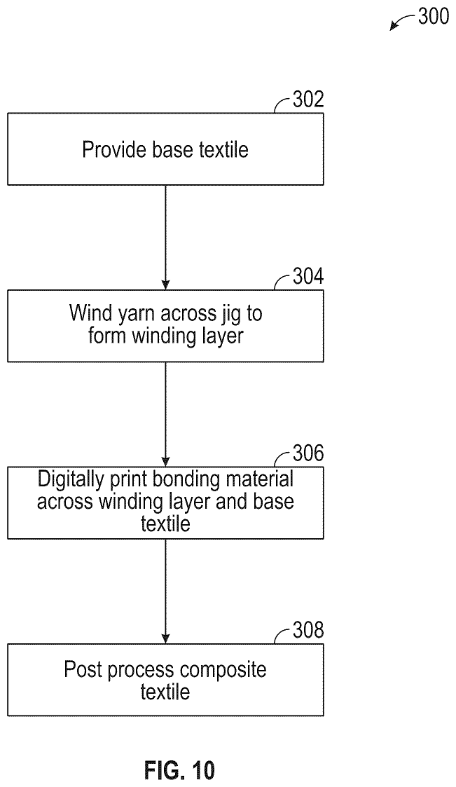

In view of the foregoing, a method 300 of manufacturing an engineered textile 10 is generally illustrated in FIG. 10. This method 300 begins at 302 by providing a suitable base textile component 14. In some embodiments, the base textile 14 may provide the engineered textile 10 with underlying coverage across some or all of the pattern or panel shape, and likewise in some embodiments the base textile 14 may contribute properties including, for example, one or more of flexibility, breathability, inherent elasticity, and durability to the engineered textile 10. The base textile is selected from materials that are knitted, or woven, or non-woven (e.g., felt, etc.). Knitted textiles provide excellent stretch and recovery through the interlooping of yarn strands. Tightness of the knit can be controlled to tune elasticity and air permeability. Woven textiles involve interweaving warp and weft yarns, typically in an orthogonal pattern. By choosing different weave styles and yarn densities, a range of mechanical properties can be achieved. The base textile material comprises natural fibers (for example, cotton, wool, etc.) synthetic polymer fibers (for example, polyester, spandex, etc.), regenerated cellulosic fibers (for example, rayon, etc.), or a combination of natural fibers and synthetic polymer fibers, a combination of natural fibers and regenerated cellulosic fibers, a combination of synthetic polymer fibers and regenerated cellulosic fibers, or a combination of natural fibers, synthetic fibers, and regenerated cellulosic fibers.

In an embodiment, the base textile 10 is produced using a wide-tube circular knitting machine. This allows generating the entire textile pattern in the desired two-dimensional panel shape for the final engineered textile component. For example, when manufacturing an engineered textile upper for footwear, the circular knitting process can produce a tubular textile body with the pattern shapes for all upper components fully formed. This includes the vamp, quarters, throat, tongue, and any other regions. A wide-tube circular knitting machine has multiple front and rear knitting beds containing needles and sinkers. Each knitting bed is supplied with one or more yarn feeds. By selectively activating certain needles during the knitting sequence, different stitches such as plain, tuck and float can be produced across the panel. This allows complete design freedom and pattern versatility. Electronics control the stitch selection along with process parameters like yarn tension and material take-up. After knitting, the base textile panel shapes may be removed from the tubular knitted body by cutting.

With the base textile produced/provided in step 302, step 304 involves winding the yarn strands that will provide directionally engineered strength and elasticity in the composite textile. The winding process begins by providing a pin jig matching or approximating the shape of the textile pattern or panel being manufactured. The pin jig has an array of small hooks, pins, or teeth around the outer perimeter that serve to secure the yarn strands during winding. The central region of the jig is open. For a planar textile panel, the jig is planar with the perimeter pins extending vertically. For a contoured panel, the jig may have a specific 3D shape of the textile component.

Multiple pin jigs can be produced and stacked in precise vertical alignment to allow simultaneously winding yarn strands on several layers. The jigs are manufactured with or subsequently provided with locating features so they self-align when stacked. This ensures accurate registration between layers for a multi-layer engineered textile. To produce the actual winding layer, the pin jig is mounted in an automated winding machine. One or more yarn spools are loaded into the winding system and the yarn may be threaded through a tensioning system and a stepper motor-driven winding head. As the winding head rotates and/or translates relative to the jig, the yarn may be drawn around the perimeter pins and across the central area in the predetermined pattern.

The winding process allows for precise control over all yarn strand parameters. The yarn material itself is chosen based on requirements for tenacity, inherent elasticity, denier, and other performance characteristics in the final textile. The stepper motor drives combined with closed-loop control maintain extremely consistent tension in the strands as they are wrapped around the pin jig. This ensures each strand is applied with a high degree of accuracy to achieve the desired engineered properties. The exact wrapping pattern around the perimeter pins is fully defined in software and may be based, at least in part, on an FEA analysis of the final product. This allows the strands to be oriented on the textile panel such that they produce the required directional tensile strength and stretch capabilities.

After winding is complete, the pin jig is removed from the winding machine with the wound yarn strand pattern intact. The jig can be manually stacked with other winding layers, or loaded onto an assembly station for application of the bonding material. The precision winding process maximizes control and repeatability of the yarn strand parameters including orientation, spacing, tension, and elasticity.

With the yarn strands wound onto the pin jig at 304, the next step is applying a polymeric bonding material to fuse the yarn strands together and bond them to the base textile (at 306). The bonding material can be specifically formulated to exhibit properties like hardness, elasticity, flexibility, and bonding strength that are optimized for the engineered textile application. Thermoplastic polyurethane elastomers and other thermoplastic elastomers provide an excellent balance of flexibility when stretched and high bond strength when solidified.

The polymeric bonding material may include a base polymer resin and may further include one or more plasticizers, curing agents, pigments, and other performance additives using a melt-mixing or solvent blending process. The plasticizers enhance flexibility and processability of the bonding material. Curing agents allow selectively crosslinking the material after deposition for optimal mechanical properties and thermal resistance. Carbon black or other pigments may be added for desired coloration. Additional fillers, anti-static compounds, UV stabilizers, and other additives can tailor bonding performance.

The formulated polymeric bonding material is digitally deposited onto the base textile and wound yarn strands using techniques like screen printing, inkjet printing, or fused filament fabrication. Digital printing allows selectively applying the bonding material only in locations where it is required. This attaches the yarn strands to each other and bonds them to the base textile without compromising flexibility or breathability. For inkjet and extrusion processes, print resolution, drop size, printhead height, and bed temperature are dialed in to achieve accurate, repeatable results. Multiple print passes or material layers can be used to build up a target deposit thickness.

The bonding material can be printed first directly onto the base textile as a precursor layer. The wound yarn strands are then overlaid, and additional bonding material is applied. Alternating material layers are also possible. This allows tuning how deeply the bonding material penetrates into the base textile and how thoroughly it wraps around and coats the yarn strands. After printing, some bonding material chemistries require heat or UV light curing to fully crosslink and harden the polymer.

In some engineered textile constructions, additional functional layers can be laminated for features like breathability, support, or abrasion resistance. Thin polymer films with micro-perforations may be added to enhance air permeability and ventilation while still blocking moisture ingress. These films may be applied to one or both sides of the textile using the polymeric bonding material. Flexible polymer foams can provide cushioning and support. They can be cut into desired patterns and strategically bonded in localized areas that require additional impact damping or comfort. Woven or knitted textiles furnish additional abrasion resistance and durability for high wear zones, and the pile structure of brushed or flocked textiles gives an enhanced tactile feel.

These supplemental films, foams, or textiles may be precisely cut to shape using die cutting, laser cutting or automated cutting machines. They are optionally pre-treated with heat, plasma, or other surface activation to enhance bonding. The additional layers are then laminated to the engineered textile assembly using the polymeric bonding material. This bonds them to the wound yarn strands and base textile in the desired locations based on the application requirements. The bonding material is printed or deposited in patterns between the layers and allowed to cure fully.

The supplementary layers expand the engineering options for the textile by allowing hybrid constructions with polymer, foam, and textile components. This additional construction provides an ability to optimize the design to enhance comfort, breathability, elasticity, support, traction, abrasion resistance, and other performance characteristics. The polymeric bonding material may be selected or formulated to maximize adhesion with the specific materials being combined in the laminate structure.

Finally, at step 308, post-shaping heating or secondary curing/crosslinking can be performed to maximize bonding between the layered materials for optimal durability and component life. For example, heating under pressure from platens or rollers helps the bonding material reflow and further penetrate the yarn strands and base textile. This additional bonding improves interlayer adhesion, fray resistance, and structural integrity. It also sets any residual stresses from shaping to prevent distortion. The completed engineered textile provides the combined benefits of comfort, breathability, and elasticity from the base textile, plus directionally engineered strength and flexibility from the strategically oriented and bonded yarn strands.

In view of the preceding disclosure, other similar methods of manufacture are possible and may be suitable for creating an engineered composite textile 10. For example, in one method, the base textile 14 may be placed or mounted on a jig. The yarn strands 12 are then wound directly onto the same jig, overlaying the base textile 14. With the base textile 14 and wound yarn strands 12 intact on the same jig, the polymeric bonding material 16 is printed across both materials to fuse them together into the engineered composite textile 10. The bonding material 16 penetrates through the yarn windings to securely anchor with the underlying base textile 14.

In another method, the base textile 14 may be positioned on a first jig. The yarn strands 12 are wound separately onto one or more second jigs. The winding jig(s) with yarn strands 12 intact are then stacked precisely on top of the first jig carrying the base textile 14 into a multilayer assembly. Polymeric bonding material 16 is applied by printing across the layers to fuse the yarn strands 12 to the base textile 14.

In still another embodiment, the base textile 14 may be mounted on a first jig and the yarn strands 12 wound on the same first jig in direct contact with the base textile 14. A polymeric bonding material 16 is separately deposited in the desired pattern onto the surface of a second jig or platen by techniques including screen printing or fused filament fabrication. The secondary jig carrying the printed bonding material 16 is brought into contact with the first jig carrying the base textile and wound layers. Heat may be applied uniformly in this assembly to allow the bonding material 16 to penetrate through the yarn windings 12 into the base textile 14. Alternatively, precise heat may be applied only to selected areas of the jig to provide targeted penetration of the bonding material 16.

In another embodiment, the base textile 14 and yarn windings 12 may be layered on jig(s) as described above. The polymeric bonding material 16 is printed onto a secondary surface and then transferred to the textile materials. Heat and pressure are applied selectively across the textile by means of shaped pressure pads. This allows the bonding material 16 to reflow for superior adhesion and deeper penetration in certain areas that correspond with the pressure pad shapes. The heat further removes stresses from the material deformation under the applied pressure.

In another embodiment, independent jigs may hold the base textile 14 and yarn windings 12 respectively. The jigs are aligned in precise, adjacent configuration allowing the discrete material layers to come into direct contact. One or more bonding material layers may be separately created and then stacked between adjacent ones of the jigs. The bonding material layers may be formed by printing the polymeric bonding material 16 onto a secondary surface and allowing it to solidify and/or partially cure before transferring it to the textile materials. In some embodiments, additional polymeric bonding material 16 may be screen printed or otherwise deposited across the stacked layers in this relative arrangement. Uniform pressure and/or heat may be added during the bonding process to reflow the pre-printed bonding material layers enhance adhesion between the layers 12, 14, 16 forming the engineered textile 10.

In an embodiment, multiple layers of one or more base textiles 14 may be incorporated in discrete zones across the textile panel shape. The secondary base textile layers may be cut precisely to shape and stacked above specific areas of the primary base textile. Yarn windings 12 may then be stacked or wound across the varying textile stack height, where the yarn layout bridges between and/or across the differential base textile levels. Polymeric bonding material 16 may then be applied in any of the manners disclosed herein to anchors the yarn strands 12 to the base textile stackup and further bond them to the discrete multi-level textile substrates. The complex topography may provide tailored cushioning and support.

In another embodiment, the base textile 14 may be cut into two or more discrete segments separated by open zones in the panel shape. Yarn strands 12 are wound across the full pattern bridging between the discontinuous textile sections. Polymeric bonding material 16 may then be applied to the yarn strands 12 to secure the yarn strands 12 to the respective, separated textile sections. In such a manner, the yarn strands interconnect the two separated textile sections and thus incorporate multiple textile substrate sections into a larger continuous panel with increased anisotropy due to the isolated textile geometry.

In some embodiments, multiple different polymeric bonding materials may print during the bonding process. For example, an initial flexible, low-hardness bonding polymer may be used to integrate the yarn windings 12 and base textile 14. Secondary print passes then selectively apply a reinforcing polymer with higher rigidity and strength only along or across certain yarn strands or in defined regions requiring added structural support or abrasion resistance. Similarly, a plurality of pre-formed bonding material layers may be stacked with the base textile and various winding layers, where a first one of the plurality of bonding material layers has a different shape and/or material property (e.g., hardness, elasticity, rigidity, bonding affinity, etc) than a second one of the plurality of bonding material layers.

The engineered composite textile 10 produced by this manufacturing method 300 provides a novel balance of properties and performance. The base textile 14 gives the composite textile 10 underlying coverage across the full pattern or panel shape. Being knitted or woven, the base textile contributes inherent comfort and breathability next to the skin. The porosity from the interlooped or interwoven structure allows air circulation and moisture management. The base textile also provides multidirectional stretch from its intrinsic construction.

Augmenting this coverage and elasticity, the strategically wound and bonded yarn strands supply directionally engineered tensile strength and elasticity. The custom winding patterns, polymeric bonding material, and tailored yarn parameters allow selectively locating reinforcement, restricting stretch, and tuning elastic recovery in targeted directions. This anisotropic behavior better distributes and carries stresses from the end use application to minimize shear and maximize durability.

The combination maximizes comfort along with engineered performance in a novel engineered composite textile. The manufacturing techniques provide flexibility for on-demand customization of mechanical properties and material placement tailored to the end use. The result is high performance textiles with an optimal balance of comfort, fit, breathability, elasticity, and durability surpassing limitations of traditional textile manufacturing.

Non-limiting examples of engineered composite textiles that may be formed through the techniques described herein include composite textiles formed with the following ordered stacked structures: base textile, and one or more sets of (one or more bonding material layers and one or more winding layers) or (one or more winding layers and one or more bonding material layers); base textile, bonding material one or more winding layers, bonding material, second base textile; or any and all combinations of a base textile, one or more winding layers, and one or more bonding material layers. Further one or more supplementary layers, such as rigid or semi-rigid polymer materials, polymeric membranes, foam materials, or other woven or non-woven textile materials may be interleaved into any one or more ordered stacked structures in whole or in part or at multiple locations within the ordered stacked structures. In some embodiments, multiple dissimilar winding layers may be stacked in an abutting relationship without any other intermediate layers, structures, or materials, with bonding material layers applied to the end winding layers of the stack. As a short listing of examples, where T represents a textile layer, W represents a winding layer, B represents a bonding material layer, and the subscript “n” denotes n-possible repeating sets of the subscripted layer or set of layers, potential stackups may include, without limitation: TWB; TBWB; TWₙB; T(BW)ₙB; T(WB)ₙ; T(WₙB)ₙ; T((BWₙ)ₙBT)ₙ; TBT(WₙB)ₙ; or any combination of multiple sub-stacks selected from this list, including duplicates of the same stack (e.g, (TWB)ₙ, (TWB)(TBWB)). Any of the stackups disclosed in the prior sentence can comprise the entire expanse of an engineered composite panel or sheet or instead can comprise only a portion of an expanse of an engineered composite textile panel or sheet, and/or can comprise an entire thickness of an engineered composite panel or sheet or instead can comprise only a portion of a total thickness of an engineered composite panel or sheet. Further examples may include any of the preceding, though with one or more membranes, foam layers, textiles, or rigid or semi-rigid polymeric materials inserted, bonded, fused, secured, or captured between any two or more of the denoted layers. Similarly, the stackup need not be uniform across the entire panel or pattern. For example, in one region of the panel, the stackup may be a first stackup (e.g., TWB), whereas in another region the stackup may be a second stackup that is different from the first stackup (e.g., TBWBT or TMWB, where M denotes a membrane layer, for example a thermoplastic membrane layer). Embodiments of the invention can likewise include a stackup having one or more thermoplastic membrane layers disposed between any two other layers in any of the above listed potential stackups, for example between T and B layers (e.g., in -TMB- or -BMT- arrangements), between B and W layers (e.g., -BMW- or -WMB- arrangements), between T and W layers (e.g., -TMW- or -WMT- arrangements), between adjacent winding layers (e.g., -WMW-), between adjacent bonding layers (e.g., -BMB-), or between adjacent textile layers (e.g., -TMT-). In contemplated embodiments having two or more thermoplastic membrane layers, two or more of the membrane layers can be directly adjacent one another (e.g., a -(M)ₙ- arrangement within a stackup), or can be separated from one another by one or more of the T, B, and W layers in any arrangement (e.g., -TMWMWB-, -TWMWMB-, -TMWBMB-, etc.). Likewise, a thermoplastic membrane can also be disposed as an uppermost layer in any of the above presented stackups.

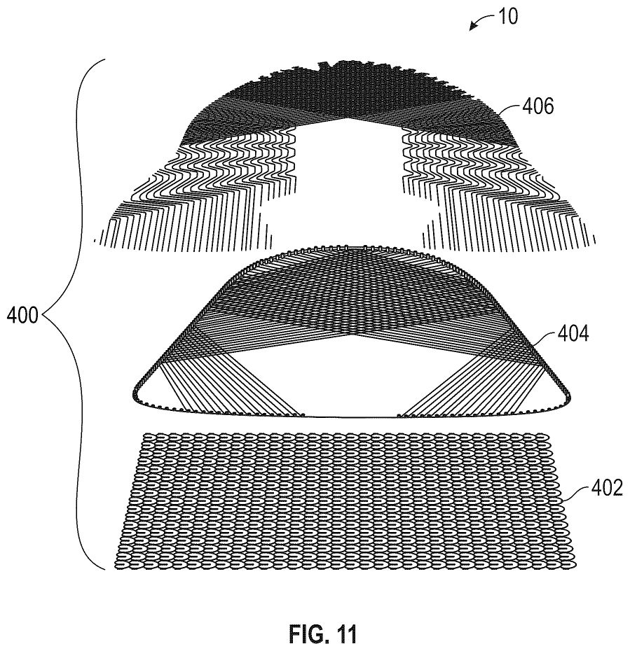

In view of this disclosure, and solely in an effort to provide illustrative examples of various combinations material layers, FIGS. 11-18 illustrate eight different embodiments of engineered composite textiles in exploded form. It should be appreciated in view of all that is disclosed herein that these illustrative composites are in no way intended to be limiting, but rather should highlight possible levels of structural complexity that may be achieved with the present techniques.

FIG. 11 schematically illustrates an exploded view of a first embodiment 400 of an engineered composite textile 10. This first embodiment 400 includes a textile layer 402, a winding layer 404, and a bonding material layer 406. The winding layer 404 is between the bonding material layer 406 and the textile layer 402, and is operatively secured to the textile layer 402 via bonding that occurs between the material of the bonding layer 406 and the material of the textile layer 402 in areas between adjacent yarns of the winding layer 404.

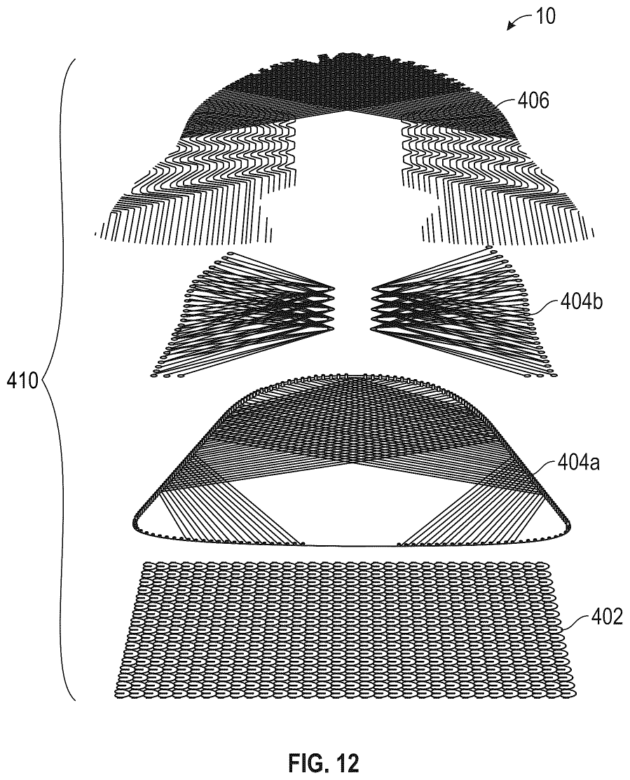

FIG. 12 schematically illustrates an exploded view of a second embodiment 410 of an engineered composite textile 10. This second embodiment 410 is much like the first embodiment 400, though includes both a first winding layer 404a and a second winding layer 404b provided between the textile layer 402 and the bonding material layer 406.

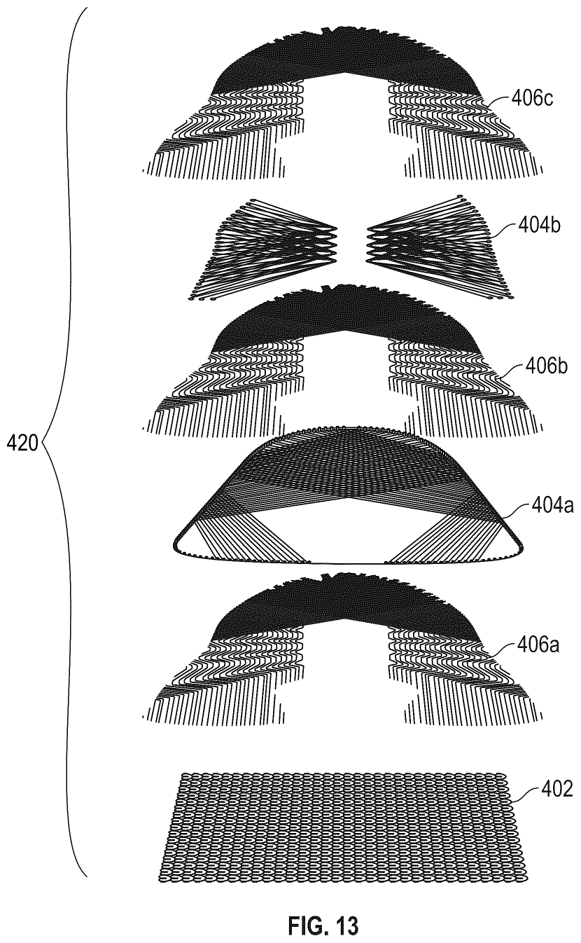

FIG. 13 schematically illustrates an exploded view of a third embodiment 420 of an engineered composite textile 10. This third embodiment 420 is much like the second embodiment 410, though includes a first bonding material layer 406a between the first winding layer 404a and the textile layer 402, a second bonding material layer 406b between the second winding layer 404b and the first winding layer 404a, and a third bonding material layer 406c on the opposite side of the stack from the textile layer 402. In this embodiment, the bonding material of the various bonding material layers 406a, 406b, 406c effectively encapsulates portions of the various yarns in the winding layers 404a and 404b.

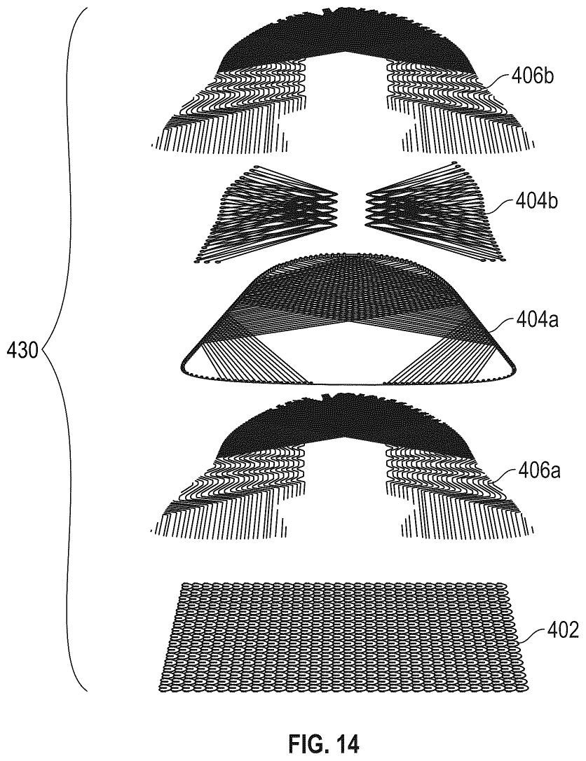

FIG. 14 schematically illustrates an exploded view of a fourth embodiment 430 of an engineered composite textile 10. This fourth embodiment 430 is much like the second embodiment 410, though it includes a first bonding material layer 406a between the first winding layer 404a and the textile layer 402 in addition to the second bonding material layer 406 on the opposite side of the stack from the textile layer 402.

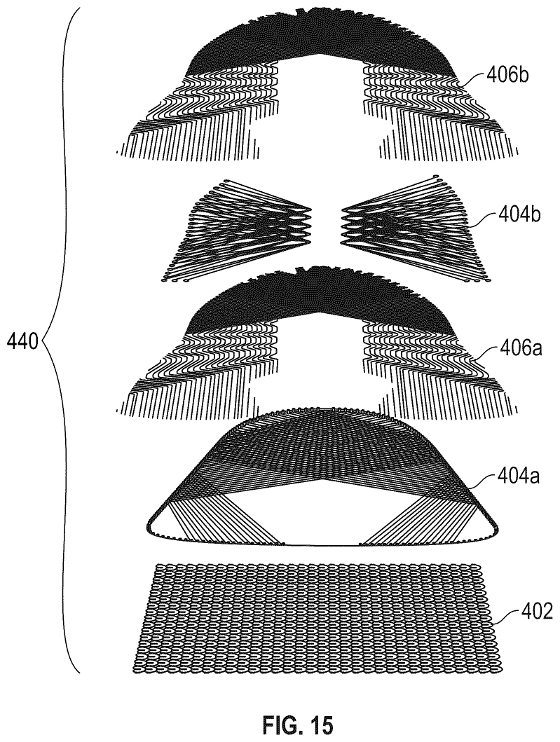

FIG. 15 schematically illustrates an exploded view of a fifth embodiment 440 of an engineered composite textile 10. This fifth embodiment 440 is much like the fourth embodiment 430, though the first bonding material layer 406a is positioned between the first winding layer 404a and the second winding layer 404b.

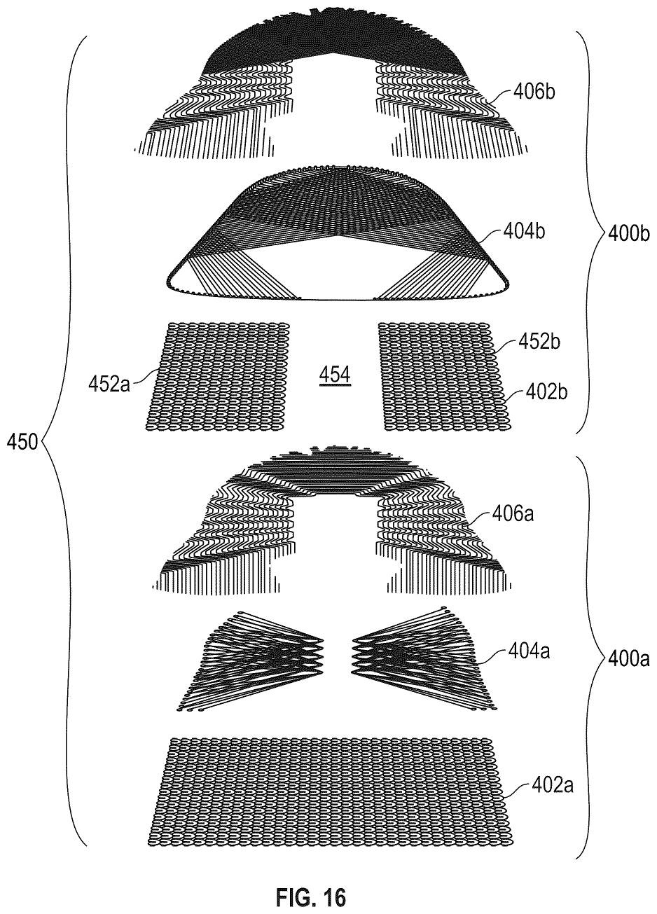

FIG. 16 schematically illustrates an exploded view of a sixth embodiment 450 of an engineered composite textile 10. This sixth embodiment 450 includes a first textile layer 402a, a first winding material layer 404a, a first bonding material layer 406a, a second textile layer 402b, a second winding material layer 404b, and a second bonding material layer 406b. Such an embodiment is akin to a first stack of the first embodiment 400a (i.e., from FIG. 11) being layered on top of a second stack of the first embodiment 400b, even though the two stacks are different at the layer-level (e.g., the first and second winding layers 404a and 404b are not the same).

As further illustrated in FIG. 16, in some embodiments, the textile layer (e.g., the second textile layer 402b) may include a first region having a first base textile 452a and a second region having a second base textile 452b, where the first base textile is separated from the second base textile by a gap 454. The winding layer (e.g., the second winding layer 404b) may extend across the gap 454 such that the first base textile 452a is effectively interconnected to the second base textile 452b across the gap 454 via at least the plurality of yarn strands in the winding layer.

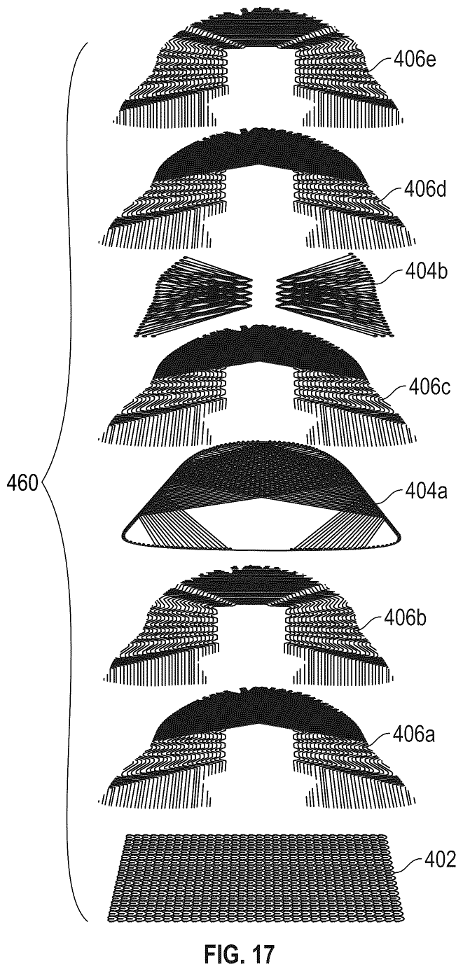

FIG. 17 schematically illustrates an exploded view of a seventh embodiment 460 of an engineered composite textile 10. This seventh embodiment 460 includes a textile layer 402, a first bonding material layer 406a, a second bonding material layer 406b, a first winding layer 404a, a third bonding material layer 406c, a second winding layer 404b, a fourth bonding material layer 406d and a fifth bonding material layer 406e. In this embodiment, the first and second bonding material layers 406a and 406b may be directly adjacent in the stack-up, but they may have different patterns or use different materials to accomplish different functional purposes. In a similar manner, the fourth and fifth bonding material layers 406d and 406e are also directly adjacent but may have dissimilar patterns or material compositions.

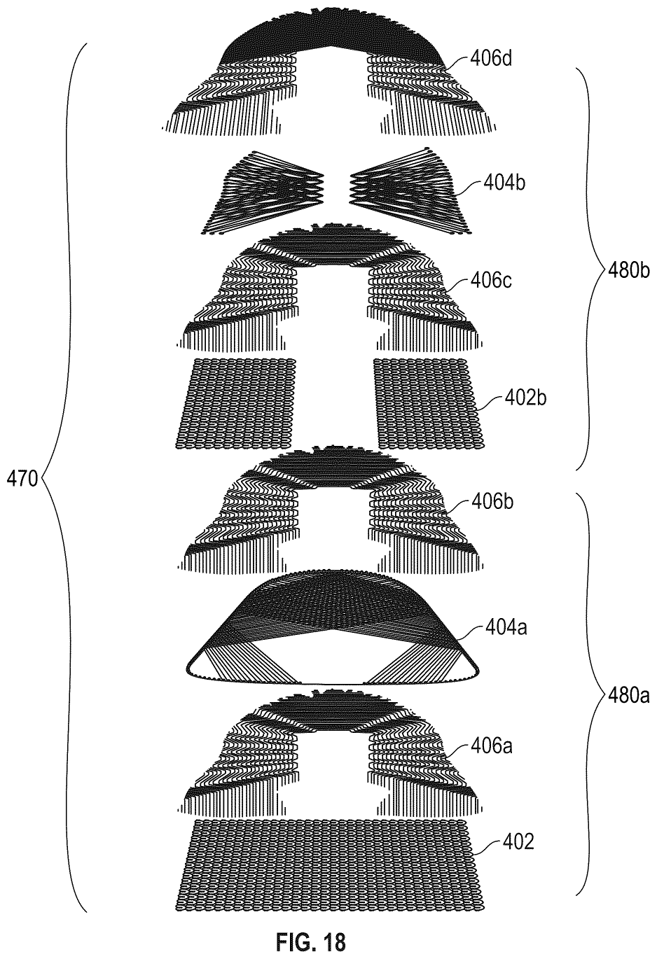

FIG. 18 schematically illustrates an exploded view of an eighth embodiment 470 of an engineered composite textile 10. The eighth embodiment 470 in FIG. 18 may be similar to the sixth embodiment 450 in FIG. 16, though may include additional bonding material layers between the windings 404a, 404b, and the adjacent textile layers 402a, 402b. More specifically, the eighth embodiment, 470 may include and ordered stack of a first textile layer 402a, a first bonding material layer 406a, a first winding layer 404a, a second bonding material layer 406b, a second textile layer 402b, a third bonding material layer 406c, a second winding layer 404b, and a fourth bonding material layer 406d. As shown, much like the sixth embodiment 450 is a sack of two structures of the first embodiment 400a, 400b, this eighth embodiment 480 may be formed from a first stack of a ninth embodiment 480a and a second stack of a ninth embodiment 480b. The ninth embodiment may be similar to the second embodiment 410, though may only have a single winding layer per sub-stack.

From these various embodiments, it should be understood that layers may be repeated within a structure, even if in a directly adjacent order, and entire stacks may be repeated to form taller and more complex structures (much like FIGS. 16 and 18). It should be understood that these embodiments may further include one or more membranes, foam layers, textiles, or rigid or semi-rigid polymeric materials inserted, bonded, fused, secured, or captured between any two or more of the illustrated layers.

Further embodiments and examples of the present disclosure are provided in a non-limiting manner in the following clauses:
Clause 1. A method of manufacturing an engineered composite textile, the method comprising: winding a yarn across a winding jig a plurality of times to form a plurality of yarn strands extending across a central area of the winding jig; stacking the winding jig with the plurality of yarn strands onto a base textile; and digitally printing a polymeric bonding material in a predetermined pattern across the plurality of yarn strands to bond the yarn strands to the base textile to create an engineered composite textile.

Clause 2. The method of clause 1, wherein at least a subset of the yarn strands are parallel and transversely spaced such that the bonding material extends between adjacent ones of the plurality of yarn strands an into contact with the base textile.

Clause 3. The method of clause 1, wherein winding the yarn across the winding jig comprises winding the yarn around a plurality of pins arranged around a perimeter of the winding jig.

Clause 4. The method of clause 1, wherein the winding jig is a first winding jig, the method further comprising: winding a second yarn across a second winding jig a plurality of times to form a second plurality of yarn strands extending across a central area of the second winding jig; and stacking the second winding jig and second plurality of yarn strands and digitally printing a polymeric bonding material in the predetermined pattern across the second plurality of yarn strands to bond the second plurality of yarn strands to the base textile and create a multi-layer engineered composite textile.

Clause 5. The method of clause 1, wherein the base textile is a knitted material.

Clause 6. The method of clause 1, wherein the polymeric bonding material comprises a thermoplastic polyurethane.

Clause 7. The method of clause 1, further comprising applying heat to the engineered composite textile to reflow the polymeric bonding material after printing.

Clause 8. The method of clause 1, further comprising cutting the base textile into a predetermined pattern before stacking the winding jig onto the base textile.

Clause 9. The method of clause 8 wherein the predetermined pattern corresponds to a component of an article of apparel.

Clause 10. The method of clause 1, wherein digitally printing the polymeric bonding material provides an areal coverage percentage between 5% and 95%.

Clause 11. The method of clause 1, wherein the engineered composite textile exhibits anisotropic elasticity based on the orientation of the plurality of yarn strands.

Clause 12. The method of clause 1, further comprising securing end portions of the plurality of yarn strands to a perimeter of the winding jig after winding the yarn across the jig.

Clause 13. The method of clause 1, wherein digitally printing comprises printing multiple bonding materials with differing material properties onto the base textile and yarn strands.

Clause 14. A method of manufacturing an engineered composite textile-based component, the method comprising: knitting a base textile having a predetermined pattern; winding a yarn across a winding jig in an engineered pattern to form a plurality of yarn strands extending across the winding jig; stacking the winding jig and the plurality of yarn strands onto the base textile; and printing a polymeric bonding material onto the base textile and across the plurality of yarn strands to fuse the yarn strands to the base textile.

Clause 15. The method of clause 14, wherein the predetermined pattern corresponds to a shape of the textile-based component.

Clause 16. The method of clause 14, further comprising cutting the base textile into the predetermined pattern after knitting and before stacking the winding tool.

Clause 17. The method of clause 14, wherein the polymeric bonding material comprises a thermoplastic polymer.

Clause 18. The method of clause 14, wherein printing the polymeric bonding material fuses the base textile and yarn strands into a component for an article of apparel.

Clause 19. The method of clause 14, wherein the engineered pattern of the yarn strands creates directional elasticity in the textile-based component.

Clause 20. An engineered composite textile having a stackup structure defined by any of: TWB; TBWB; TWₙB; T(BW)ₙB; T(WB)ₙ; T(WₙB)ₙ; T((BWₙ)ₙBT)ₙ; or TBT(WₙB)ₙ, wherein T represents a textile layer, W represents a winding layer, B represents a bonding material layer, and the subscript “n” denotes n-possible repeating sets of the subscripted layer or set of layers.

Clause 21. The engineered composite textile of clause 20 formed by the method of any of clauses 1-19.

Clause 22. The engineered composite textile of either of clauses 20 or 21, further comprising at least one membrane layer disposed between any two directly adjacent layers in the stackup.

Clause 23. The engineered composite textile of clause 22, wherein the membrane layer is a thermoplastic membrane layer

Clause 24. The engineered composite textile of any of clauses 22 or 23, wherein the stackup includes at least one grouping of: TMB, BMT, BMW, WMB, TMW, WMT, WMW, MBM, Mₙ, TMT, TMWMWB, TWMWMB, TMWBMB, where M represents a membrane layer.

What is claimed:

1. A method of manufacturing an engineered composite textile, the method comprising:
winding a yarn across a winding jig a plurality of times to form a plurality of yarn strands extending across a central area of the winding jig, wherein the plurality of yarn strands are non-interlocking with each other;
positioning the winding jig with the plurality of yarn strands relative to a base textile such that the plurality of yarn strands overlie the base textile; and
selectively applying a polymeric bonding material across the plurality of yarn strands and into contact with the base textile to bond the yarn strands to each other and to the base textile.

2. The method of claim 1, further comprising:
prior to positioning the winding jig, applying a first layer of the polymeric bonding material onto the base textile; and
wherein selectively applying the polymeric bonding material across the plurality of yarn strands comprises applying a second layer of the polymeric bonding material that contacts the first layer between adjacent yarn strands.

3. The method of claim 1, wherein selectively applying the polymeric bonding material comprises printing or extruding the polymeric bonding material in a predetermined pattern.

4. The method of claim 1, wherein the winding jig is a first winding jig and the plurality of yarn strands are a first plurality of yarn strands, the method further comprising:
winding a second yarn across a second winding jig a plurality of times to form a second plurality of yarn strands extending across a central area of the second winding jig;
positioning the second winding jig with the second plurality of yarn strands onto the first plurality of yarn strands; and
wherein the selectively applying a polymeric bonding material includes selectively applying the polymeric bonding material across the second plurality of yarn strands to bond the second plurality of yarn strands to the first plurality of yarn strands and to the base textile.

5. The method of claim 4, wherein:
the first plurality of yarn strands are aligned along a first common direction and have a first material elasticity;
the second plurality of yarn strands are aligned along a second common direction and have a second material elasticity different from the first material elasticity; and
the first common direction is oblique to the second common direction.

6. The method of claim 1, wherein at least a subset of the yarn strands are parallel to each other and transversely spaced such that the polymeric bonding material extends between adjacent ones of the plurality of yarn strands and into contact with the base textile.

7. The method of claim 1, wherein the base textile is a knitted material.

8. The method of claim 1, wherein the polymeric bonding material comprises a thermoplastic polyurethane.

9. The method of claim 1, wherein selectively applying the polymeric bonding material provides an areal coverage percentage between 5% and 95%, or provides varying areal coverage percentages in different regions of the engineered composite textile.

10. The method of claim 1, further comprising applying heat to the engineered composite textile to reflow the polymeric bonding material after selectively applying the polymeric bonding material.

11. The method of claim 1, further comprising:
placing a pre-formed component onto the plurality of yarn strands or the base textile; and
wherein selectively applying the polymeric bonding material further bonds the pre-formed component to the engineered composite textile.

12. The method of claim 1, wherein the plurality of yarn strands are oriented along expected load paths in a final article such that tensile loads are carried primarily by the yarn strands.

13. The method of claim 1, further comprising constructing an article of footwear that includes at least a portion of the engineered composite textile.

14. An article of footwear comprising:
an upper defining an interior cavity configured to receive a foot; and
a sole structure attached to the upper;
wherein at least a portion of the upper comprises an engineered composite textile, the engineered composite textile including:
a base textile layer;
a plurality of oriented yarn strands overlying the base textile layer, wherein the plurality of yarn strands are non-interlocking with each other; and
a polymeric bonding material bonding the plurality of yarn strands to each other and to the base textile layer;
wherein the engineered composite textile exhibits directionally-dependent mechanical properties based on orientation of the plurality of yarn strands.

15. The article of footwear of claim 14, wherein the plurality of yarn strands includes:
a first subset of yarn strands extending in a first common direction and having a first material elasticity; and
a second subset of yarn strands extending in a second common direction that is oblique to the first common direction and having a second material elasticity different from the first material elasticity.

16. The article of footwear of claim 14, wherein the base textile layer comprises a knitted material or a woven material.

17. The article of footwear of claim 14, wherein the polymeric bonding material has varying areal coverage percentages in different regions of the engineered composite textile.

18. The article of footwear of claim 14, wherein the polymeric bonding material penetrates into a structure of the base textile layer.

19. The article of footwear of claim 14, wherein the plurality of oriented yarn strands are aligned along load paths corresponding to expected tensile loading during use of the article of footwear.

20. An engineered composite textile comprising:
a base textile layer;
a plurality of oriented yarn strands overlying the base textile layer, wherein the plurality of yarn strands are non-interlocking with each other; and
a polymeric bonding material bonding the plurality of yarn strands to each other and to the base textile layer;
wherein the engineered composite textile exhibits directionally-dependent mechanical properties based on orientation of the plurality of yarn strands.
